(19) United States
(12) Patent Application Publication
(10) Pub. No.: US 2010/0276854 A1
(43) Pub. Date: Nov. 4, 2010

(54) Spring support for industrial vibrator

(76) Inventor: Kyle Lanson Davis, Dixon, KY (US)

Correspondence Address: Kyle L Davis, 1404 Hwy 41A North, Dixon, KY, 42409, US

(21) Appl. No.: 12/387,354

(22) Filed: Apr. 30, 2009

(51) Int. Cl. F16F 15/02

(52) U.S. Cl. 267/140.13

(57) ABSTRACT

An easily serviced spring mounting base assembly for use with heavy vibratory equipment such as might be used in mined minerals segregation. The base plate having a plurality of spring openings, a compression spring below each of the spring openings, the individual compression springs supported by a single foundation and individual cover plates sized to cover the required spring openings; the spring openings sized so that the compression spring diameter is allowed to pass through. The cover plates and base plate having a plurality of aligned holes to receive bolts such that tightening the bolts compresses the spring between the cover plate and the foundation, and secures the cover plate to the base plate.

### CROSS REFERENCES TO RELATED APPLICATIONS

Not Applicable

### STATEMENT AS TO RIGHTS TO INVENTIONS MADE UNDER FEDERALLY SPONSORED RESEARCH AND DEVELOPMENT

Not Applicable

### BACKGROUND OF THE INVENTION

1. Field of the Invention

The invention relates generally to spring supports and more particularly to a spring support base for use in application, such as heavy industrial vibrators or material separation segments.

2. Brief Description of Prior Art

Prior art spring supports do not allow for the safe and efficient exchange of these large spring systems. Prior art designs require that the entire machine weight be relieved from the springs at a particular foundation leg. This is more difficult, time consuming, and less safe than the procedure allowed by the present invention.

As will be seen from the subsequent description, the preferred embodiments of the present invention overcome disadvantages of the prior art.

### SUMMARY OF THE INVENTION

In accordance with the present invention, a spring base assembly for use with heavy vibratory equipment is disclosed. The assembly includes a base plate having a plurality of spring openings, a compression spring below each of the openings, the compression spring supported on a foundation and a cover plate sized to cover the spring opening. The cover plate having a plurality of holes to receive bolts such that tightening the bolts compresses the spring between the cover plate and the foundation and secures the cover plate to the base plate. Said base plate spring openings are sized so that the spring diameter will fit through the opening.

Present invention allows for the easy, safe, and efficient exchange of vibrator springs. These accomplishments are allowed by the utilization of individual spring cover plates. Said cover plates allow for the removal of an individual spring without the need to remove the total weight of the supported machine.

### BRIEF DESCRIPTION OF THE DRAWINGS

Having thus described the invention in general terms, reference will now be made to the accompanying drawings, which are not necessarily drawn to scale, and wherein:

FIG. 1 is a top view of the spring base assembly constructed in accordance with the preferred embodiment of the invention.

FIG. 2 is a side view of the base of FIG. 1

FIG. 3 is a side view of the details of the base shown in FIG. 1

FIG. 4 shows the embodiment of FIG. 1 with some parts removed

### DETAILED DESCRIPTION OF THE INVENTION

The present inventions now will be described more fully hereinafter with reference to the accompanying drawings, in which some examples of the embodiments of the inventions are shown. Indeed, these inventions may be embodied in many different forms and should not be construed as limited to the embodiments set forth herein; rather, these embodiments are provided by way of example so that this disclosure will satisfy applicable legal requirements. Like numbers refer to like elements throughout.

The apparatus of the present invention is directed to a spring base assembly for use in applications such as heavy industrial vibrators or material segregation segments. Specifically, it will be noted in the drawings that the spring support base of the present invention provides a safe and efficient exchange of these large spring systems. In the broadest context, the spring base of the present invention consists of components configured and correlated with respect to each other so as to attain the desired objective.

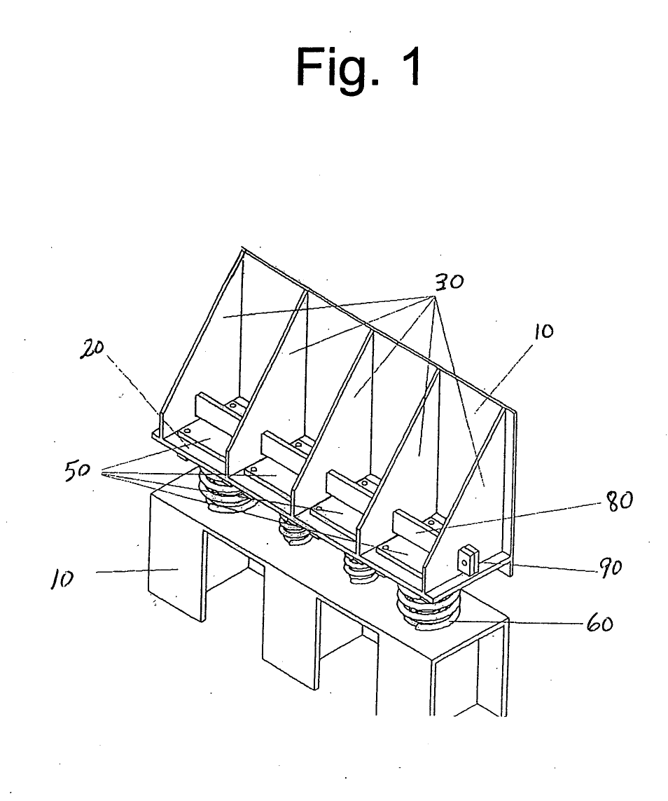

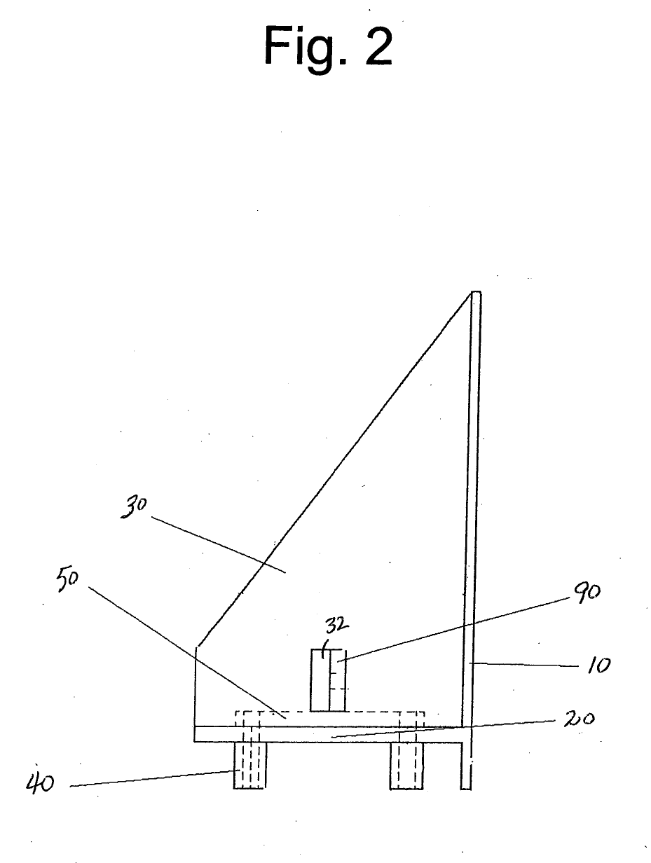

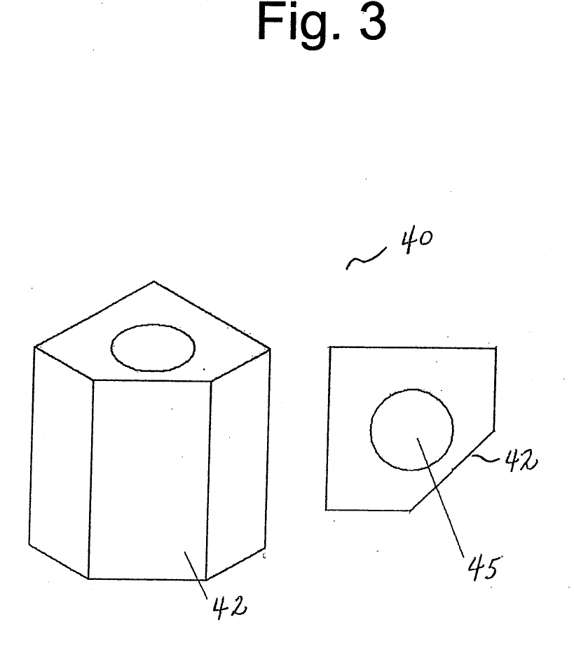

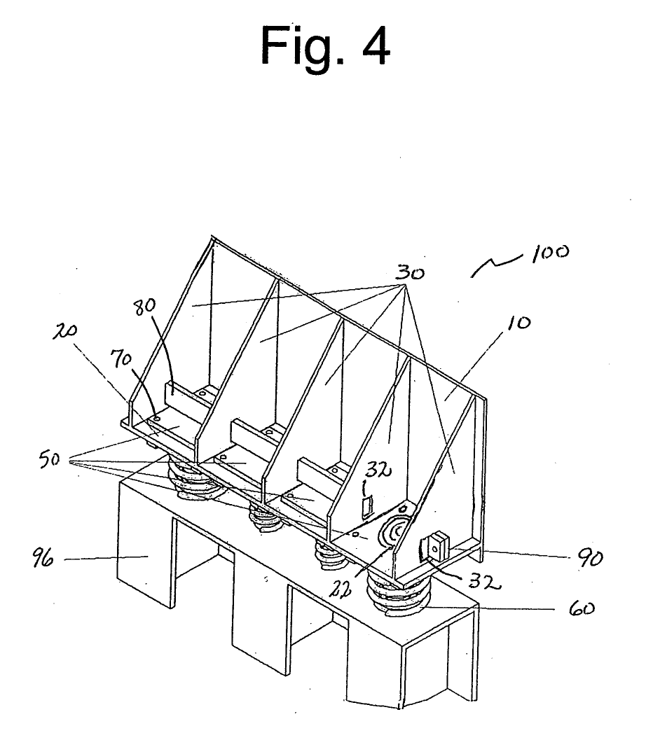

FIGS. 1-4 illustrate a preferred embodiment of the spring base assembly of the present invention. In one embodiment, the base 100 includes a mounting plate 10 for connection to the vibrator (not shown). Mounting plate 10 is a flat metal plate that can be modified to fit the specific application. Spring insert 20 is a flat plate with openings 22 (see FIG. 4) cut for the individual springs 60 to be inserted or removed from above, as well as passage through of the bolts 70. The holes 22 cut in the top of plate 20 will be determined by the size of the machine springs 60. Plate 20 is connected to plate 10 such as by welding. Girder plates 30 are also connected such as by welding to plates 10 and 20 as illustrated. Retainers 40 are threaded to hold the retention plates 50 into place via four (4) bolts 70 each. Retainers 40 can be formed by machining and will have a threaded hole 41 completely through, and will be threaded for the bolts 70 that hold the retention plates 50 into place. Retainers 40 are connected such as by welding to the underside of spring insert plate 20 and will have a beveled edge 4 as seen in FIG. 3 to form a clearance of the springs 60.

Retention plate 50 is a retention plate for holding the springs 60 into place in compression. Plate 50 will have holes 51 drilled through for passage of the bolts 70. The number and size of holes 51 will be determined by the application. Compression sprigs 60 support and dampen the vibrator. The size and quality of springs 60 will be determined by the application, the springs 60 have a free (unloaded) length and they are held compressed by the retention plates 50 and bolts 70.

Item 96 is the foundation support for the springs 60 and overall base of the vibrator system which is determined by the application. The horizontal crossbar 80 is to run the length of the apparatus 100 and is necessary to prevent dangerous failure during normal operations. Holes 32 (see FIG. 4) will be cut through the girder plates 30 in order to accept the bar 80. The horizontal crossbar 80 will be held into place by nut and bolt through a tab 90 that is welded to the outside of the end girders 30.

FIG. 4 shows the foundation 100 with one of the plates 50 removed so that the cutout 22 is visible. In FIG. 4, part of the bar 80 is shown removed.

### How the Invention Works:

The following steps are necessary to replace or repair a vibrator spring 60 using the new apparatus 100. The only tools required are a wrench and/or sockets (not shown).
1.) Remove the bolt 92 holding bar 80 to tab 90 on both ends of the apparatus.
2.) Slide the bar 80 out of the slot openings 32.
3.) Remove plate 50 (above the spring 60 to be replaced) by relieving tension on the four (4) bolts 70, then removing the bolts 70 and lifting off the plate 50.
4.) Pull spring 60 out upward through the hole 22.
5.) Place in the new or repaired spring 60 through the hole 22.
6.) Place the plate 50 back over the spring hole 22.
7.) Tighten the four (4) bolts 70 back into place to compress the spring 60.
8.) Replace the bar 80 and the bolts 92 which hold it into place at tab 90.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific examples of the embodiments disclosed and that modifications and other embodiments are intended to be included within the scope of the appended claims. Although specific terms are employed herein, they are used in a generic and descriptive sense only and not for purposes of limitation.

1. A spring base assembly for use with heavy vibratory equipment, the spring base comprising:
a base plate having a plurality of spring openings,
a compression spring below each of said spring openings, said compression spring supported on a foundation,
a cover plate sized to cover each of said spring openings, said cover plate having a plurality of holes to receive bolts such that tightening the bolts compresses said spring between said plate and said foundation, and secures said cover plate to said base plate.

2. The spring base as recited in claim 1, wherein said assembly includes a bar, said bar adapted to lock said cover plate on said base plate.

3. The spring base assembly as recited in claim 1, wherein said base plate includes a plurality of triangular gussets supporting a mounting plate and wherein said triangular plates include aligned openings such that a bar can be passed into the aligned openings to act as a safety to hold said cover plates in place.
